(19) United States
(12) Patent Application Publication
(10) Pub. No.: US 2015/0057771 A1
(43) Pub. Date: Feb. 26, 2015

(54) Method And Data Collector For An Industrial Process

(71) Applicants: Lukasz Dembicki, Oslo (NO); Fredrik Galaasen, Oslo (NO); Trond Skullerud, Royken (NO); Trond Iversen, Oslo (NO)

(72) Inventors: Lukasz Dembicki, Oslo (NO); Fredrik Galaasen, Oslo (NO); Trond Skullerud, Royken (NO); Trond Iversen, Oslo (NO)

(21) Appl. No.: 14/528,659

(22) Filed: Oct. 30, 2014

Related U.S. Application Data
(63) Continuation of application No. PCT/EP2012/057922, filed on Apr. 30, 2012.

(51) Int. Cl. G05B 15/02

(52) U.S. Cl. CPC G05B 15/02
USPC 700/83

(57) ABSTRACT

A method of creating a report of a status of an industrial process. The method includes retrieving industrial process data including a predetermined amount of process variable values in response to a triggering signal, wherein the retrieving includes retrieving a first portion of industrial process data that has been generated prior to the triggering signal and a second portion of industrial process data that is generated after the triggering signal, and sending the industrial process data to a report tool to thereby create a report pertaining to the industrial process. A data collector and a control system including such a data collector are also presented herein.

### FIELD OF THE INVENTION

The present disclosure generally relates to industrial process monitoring and control and in particular to a method, a computer program product and a data collector for creating a report pertaining to an industrial process.

### BACKGROUND OF THE INVENTION

Industrial processes in fields such as pulp and paper, oil and gas, heat and power generation, and the chemical industry generally comprise a plurality of process equipment or process components for carrying out the various process steps. The operation of the process equipment is monitored, for example by means of sensors arranged to measure the process variables associated with the process equipment.

Typically, one or more operators supervise the industrial process, for example in an operator room, by means of a control and monitoring system comprising a plurality of displays displaying trends and other data related to the process variables measured by the sensors. In case of the occurrence of an event, i.e. a situation when a measured process variable value of a process variable is outside an accepted range, operators have to take action for removing the cause of the event such that the process variable returns to acceptable levels. Thereby predefined quality requirements of the end product may be kept and protection of the process equipment may be ensured.

It is typically desirable to record measured process variable values in order to be able to analyse the course of events in the case of the occurrence of an event. To this end, large amounts of data are typically continually collected such that event report generation of any event may be provided.

WO2007007200 discloses a method for automated analysis of events in an electric power system and dissemination of an event report. A set of data is received including at least one parameter of an electric power system. At least one event is detected in the set of data, wherein selected data regarding the at least one event are isolated. A report is generated based on at least one predefined format.

There are however drawbacks with previous methods for generating event reports. For example large amounts of data may constantly be needed to be transmitted over a communications network in order to be able to generate an event report.

### SUMMARY OF THE INVENTION

In view of the above, a general object of the present disclosure is to provide a method and data collector to improve report generation of industrial process data. In particular, it would be desirable to be able to reduce the amount of transmitted data for the purpose of report generation.

Hence, according to a first aspect of the present disclosure there is provided a method of creating a report of a status of an industrial process, wherein the method comprises: retrieving industrial process data comprising a predetermined amount of process variable values in response to a triggering signal, wherein the retrieving comprises retrieving a first portion of industrial process data that has been generated prior to the triggering signal and a second portion of industrial process data that is generated after the triggering signal; and sending the industrial process data to a report tool to thereby create a report pertaining to the industrial process.

By retrieving predetermined amount of process variable values that includes data generated both before and after the triggering signal, only industrial process data of interest has to be transmitted over a communications network and received by e.g. a data collector for generating the report. Since a great plurality of process variables and other process data has to be monitored for controlling an industrial process, the amount of data having to be communicated can be reduced considerably. In contrast, in the prior art for example, all industrial process data has to be collected wherein relevant portions of the data are isolated for the creation of a status report.

One embodiment comprises retrieving the industrial process data from an external server.

According to one embodiment the report tool is a spreadsheet.

One embodiment comprises periodically monitoring a parameter, which parameter provides an indication of whether an event has occurred.

According to one embodiment, the retrieving of the industrial process data comprises retrieving a predetermined number of data values sampled at instances of time that are prior to a sample time of when the event occurred, wherein the predetermined number of data values sampled at instances of time that are prior to occurrence of the event form the first portion of industrial process data.

According to one embodiment, the retrieving of the industrial process data comprises retrieving a predetermined number of data values sampled at instances of time that are after a sample time of the occurrence of the event, wherein the predetermined number of data values sampled at instances of time that are after the occurrence of the event form the second portion of industrial process data.

According to one embodiment the triggering signal is created by a user input.

One embodiment comprises, prior to the step of retrieving, receiving the triggering signal.

One embodiment comprises creating the triggering signal at predefined instances in time. To that end, the triggering signal may be created automatically, for example according to a predetermined schedule.

According to a second aspect of the present disclosure there is provided a computer program product comprising computer-executable components for causing a device to perform the steps recited in the first aspect presented herein when the computer-executable components are run on a processing unit included in the device.

According to a third aspect there is provided a data collector for creating a report of a status of an industrial process, wherein the data collector comprises: a processor arranged to retrieve industrial process data comprising a predetermined amount of process variable values in response to a triggering signal, wherein the processor is arranged such that retrieved industrial process data includes a first portion of industrial process data that has been generated prior to the triggering signal and a second portion of industrial process data that is generated after the triggering signal, wherein the processor is further arranged to send the industrial process data to a report tool to thereby create a report pertaining to the industrial process.

According to one embodiment the report tool is a spreadsheet.

According to one embodiment, the data collector is arranged to periodically monitor a parameter, which parameter provides an indication of whether an event has occurred.

According to one embodiment, the processor is arranged to retrieve a predetermined number of data values sampled at instances of time that are prior to the occurrence of the event, wherein the predetermined number of data values sampled at instances of time that are prior to the occurrence of the event form the first portion of industrial process data.

According to one embodiment, the processor is arranged to retrieve a predetermined number of data values sampled at instances of time that are after a sample time of occurrence of the event, wherein the predetermined number of data values sampled at instances of time that are after the occurrence of the event form the second portion of industrial process data.

In a fourth aspect of the present disclosure there is provided control system for an industrial process comprising: a plurality of sensors arranged to measure industrial process data pertaining to the industrial process, a server arranged to store the industrial process data, and a data collector according to the third aspect arranged to retrieve industrial process data from the server and to create a report of a status of the industrial process.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise. Moreover, any step in a method need not necessarily have to be carried out in the presented order, unless explicitly stated otherwise.

### BRIEF DESCRIPTION OF THE DRAWINGS

The specific embodiments of the inventive concept will now be described, by way of example, with reference to the accompanying drawings, in which:

FIG. 1 is a schematic view of a control system arranged to control an industrial process;

FIG. 2 depicts a flowchart of a method of generating a report of a status of an industrial process; and

FIG. 3 illustrates a schematic diagram of memory locations for example in a server, a data collector or a PLC.

### DETAILED DESCRIPTION OF THE INVENTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

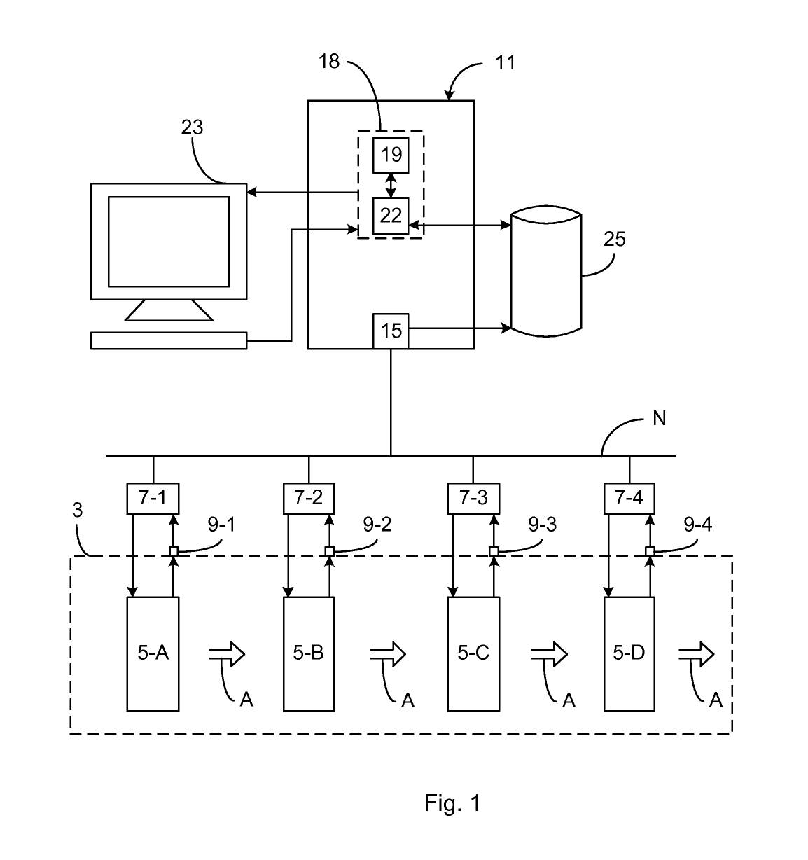

FIG. 1 schematically shows an example of a control system 1 for monitoring and controlling an industrial process 3. The industrial process 3 usually involves various process steps carried out by one or more process component 5-A, 5-B, 5-C and 5-D. The process flow according to the example of FIG. 1 is in a direction from left to right, as indicated by arrows A.

An industrial process is to be understood to mean a procedure that involves chemical, electrical or mechanical steps to aid in manufacturing, production, power generation, fabrication, or refining. Examples of such industrial processes are processes relating to the refining of oil and gas, the petrochemical industry, power generation, power transmission, power distribution, metals and mining, chemical industry, pulp and paper, or automation in e.g. the manufacturing industry or food industry. It is to be noted that the present inventive concept can be utilised for report generation for monitoring and/or control of many different types of industrial processes, with only a few examples having been given above.

The control system 1 may, for example, be a distributed control system (DCS). The control system may also be of supervisory control and data acquisition (SCADA) type or a combination of SCADA and DCS. One example of a suitable control system is the ABB® 800xA control system.

The control system 1 may comprise a plurality of control units 7-1, 7-2, 7-3, 7-4 and a plurality of sensors 9-1, 9-2, 9-3, 9-4 associated with a respective control unit 7-1, 7-2, 7-3, 7-4. Each sensor may be comprised in a respective control unit, or alternatively, the control units and sensors may be physically separate units. Each sensor 9-1, 9-2, 9-3, 9-4 of the plurality of sensors is arranged to measure one or more process variable(s) of a process component 5-A, 5-B, 5-C, 5-D. Each control unit 7-1, 7-2, 7-3, 7-4 is arranged to control a process component 5-A, 5-B, 5-C, 5-D according to a respective setpoint value which can be set by means of the control system 1.

A process component may for instance be a tank, a valve, a turbine, a roller or a cluster or rollers for a pulp and paper mill, drying equipment, a refiner, a generator, a motor, a transformer or a boiler.

A process variable is to be construed as a measurable quantity, such as pressure, temperature or voltage, associated with a process component.

The control units 7-1, 7-2, 7-3, 7-4 may for instance be Remote Terminal Units (RTU) or Programmable Logic Controllers (PLC). In one embodiment the control system comprises a combination of RTUs and PLCs. Alternatively the control system may be a centralised control system having one control unit, such as a PLC, providing control signals to one or more process components.

The control system 1 of FIG. 1 further comprises a communications network N and a data communications unit 11. The communications network N is arranged to enable data communication between the control units 7-1, 7-2, 7-3, 7-4 and the data communications unit 11. Thereby, communication may be achieved between a control system operator and the industrial process 3.

The data communications unit 11 comprises an input/output unit, I/O unit 15, arranged to communicate with the control units 7-1, 7-2, 7-3, 7-4, and a data collector 18 arranged to collect industrial process data and to generate reports based on the industrial process data.

The data collector according to the present disclosure may alternatively also be arranged in other devices. For example, the data collector may be arranged in a PLC wherein collection of industrial process data may be received directly from the PLC. If the control system comprises several PLCs, each PLC may comprise a data collector arranged to collect industrial process data associated with its PLC. Industrial process data collected by the data collector in a PLC may thereby be exported directly to a report tool such as a spreadsheet application. In this case, the data collector may be implemented as software i.e. as a computer program or a computer program product, in a processor of the PLC for carrying out the method disclosed herein.

Returning now to the example in FIG. 1, the I/O unit 15 is arranged to receive data, such as process variable data pertaining to one or more process variables, from the control units 7-1, 7-2, 7-3, 7-4. The I/O unit 15 may also be arranged to send data such as a control command to the control units 7-1, 7-2, 7-3, 7-4 for controlling the industrial process 2, e.g. by changing the setpoint value of one or more control units 7-1, 7-2, 7-3, 7-4. A control command may be based on an input command received via the input unit 21.

The data communications unit 11 is connectable to an input unit 21 such as a keyboard, mouse or a touch screen, which input unit 21 is arranged to receive input commands from a user of the control system 1, e.g. a process operator. The data communications unit 11 is further connectable to a display device 23 for displaying industrial process data received by the data communications unit 11, e.g. process variable values, and to a server 25. Although the data communications unit may be arranged to connect with a server, according to one embodiment of the data communications unit, the server discussed in the following may be integrated with the data communications unit.

The server 25, which functions as a database, is arranged to receive and store industrial process data received by the data communications unit 11 from the communications network N.

The data collector 18 comprises a processor 22. The data collector 18 may optionally also comprise a memory 19 which is in operative connection with the processor 22, for storing reports generated by the processor 18. The processor 22 comprises computer-executable components for causing the data collector 18 to perform the steps of methods of creating a report of a status of an industrial system, as will be described in more detail in the following, when the computer-executable components are run on the processor 22.

The processor 22 is arranged to communicate with the server 25 for retrieving industrial process data stored in the server 25 and to create a report based on the industrial process data retrieved from the server 25. Alternatively, for example if the data collector is arranged in a PLC, the industrial process data may be real-time data received by the data collector and utilised for report creation if e.g. it is determined that an event has occurred. A report created by the data collector 18 may be displayed on the display device 23, for example in the form of a spreadsheet.

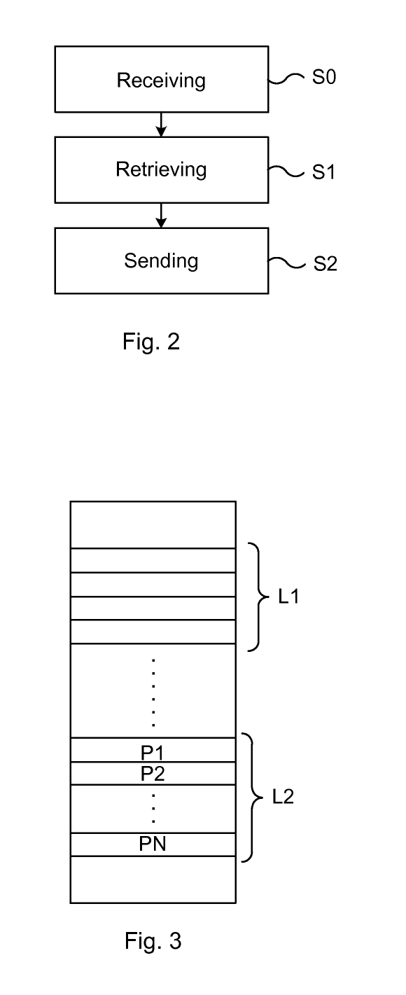

FIG. 2 shows a flowchart of a method of generating a report of a status of an industrial process. In a step S1 industrial process data is retrieved by the processor 22 in response to a triggering signal. The industrial process data is according to one embodiment retrieved from server 25, which is external to the data collector 18. In case the data collector is arranged in a PLC, the industrial process data collected by the data collector is the industrial process data received or measured by a PLC.

The triggering signal is a signal that initiates the retrieval operation of industrial process data either from the server 25 and carried out by the processor 22 or from a memory for example in a PLC. The triggering signal may be analog or it may have a Boolean value. Furthermore, the triggering signal may for example be prescheduled, it may be created in response to an occurrence of an event in the industrial process, or it may be user-initiated by a user input entered for example via the input unit 21. Depending on the application, the triggering signal may be created in response to the occurrence of an event, or externally by a user or by means of a predetermined schedule defined by a user. In the first two cases, the triggering signal is received in a step S0 before the step S1 of retrieving the industrial process data. If the triggering signal is generated by a predefined scheme, the triggering signal may be generated by the data collector 18. In the third case, i.e. when the triggering signal is prescheduled the data collector may create the triggering signal at predefined instances in time.

In realizations of the data collector that are event-driven, wherein a triggering signal is created in response to an event, the triggering signal may either be provided from an external source relative to the data collector, or it may be created by the data collector. In the latter case, the data collector may monitor one or more parameters associated with industrial process variable data received by the server 25. FIG. 3 shows a schematic diagram of memory locations for example in the server 25, in a PLC, RTU or other suitable device. In the example in FIG. 3, locations L1 are memory locations designated for industrial process data relating to process variables having values within a predetermined accepted range, while locations L2 are memory locations designated for industrial process data relating to process variable values that are outside a predetermined accepted range which may have been caused for example due to an event. Memory slots P1, P2, . . . , PN in locations L2 are associated with one or more parameters indicating whether the slots are filled with industrial process data. In case of industrial process data being stored in location L2, the data collector 18, which monitors the one or more parameters associated with memory slots P1, P2, . . . ,PN, the monitored one or more parameters indicate the state change of the memory slot(s) to the data collector 22, wherein a triggering signal is created. Thereby, the data collector 18 can retrieve industrial process data comprising a predetermined amount of process variable values from the memory slots to create a report.

The retrieving is carried out such that the industrial process data includes a first portion of industrial process data that has been generated prior to the triggering signal and a second portion of industrial process data that has been generated after the triggering signal. To this end, the first portion may comprise a predetermined number of data values sampled at instances of time that are prior to a sample time of the occurrence of the event. The second portion may comprise a predetermined number of data values sampled at instances of time that are after a sample time of the occurrence of the event. The second portion of industrial process data may typically be retrieved or collected in real-time.

Beneficially, only a limited number of industrial process data values are processed by the data collector 18. Thus, advantageously only relevant industrial process data is collected by the data collector 18. As an example, each of the first portion and the second portion may contain 300 samples of process variable values, and the entire industrial process data retrieved may comprise 601 samples of process variable values, the extra sample being the sample taken at the time when the event occurred.

In a step S2 the industrial process data is sent to a report tool to thereby create a report pertaining to the industrial process. The report tool may for instance be a spreadsheet application. An example of such a spreadsheet application is Microsoft® Excel®, in which a macro may process the industrial process data provided by the data collector to thereby present the industrial process data to a user. The report may for example comprise presentations of process variable values of one or more process variables in the form of tables, values and/or curves.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of creating a report of a status of an industrial process by means of a data collector, wherein the method comprises:
periodically monitoring one or more parameters, the one or more parameters being associated with memory slots of an external server, locations L1 being memory locations designated for industrial process data relating to process variables having values within a predetermined accepted range and locations L2 being memory locations designated for industrial process data relating to process variable values that are outside a predetermined accepted range, and the one or more parameters indicating whether memory slots in location L2 are filled with industrial process data, which one or more parameters provides an indication of whether an event has occurred, an event being a situation when a measured process variable value of a process variable is outside an accepted range, wherein in case of industrial process data being stored in location L2 the one or more parameters indicate a state change of the memory slots, wherein the method comprises creating a triggering signal,
retrieving industrial process data, from the memory slots, comprising a predetermined amount of process variable values in response to the triggering signal, wherein the retrieving comprises retrieving a first portion of industrial process data that has been generated prior to the triggering signal and a second portion of industrial process data that is generated after the triggering signal, and
sending the industrial process data to a report tool to thereby create a report pertaining to the industrial process.

2. The method as claimed in claim 1, wherein the report tool is a spreadsheet.

3. The method as claimed in claim 2, wherein the retrieving of the industrial process data comprises retrieving a predetermined number of data values sampled at instances of time that are prior to a sample time of when the event occurred, wherein the predetermined number of data values sampled at instances of time that are prior to occurrence of the event form the first portion of industrial process data.

4. The method as claimed in 1, wherein the retrieving of the industrial process data comprises retrieving a predetermined number of data values sampled at instances of time that are after a sample time of the occurrence of the event, wherein the predetermined number of data values sampled at instances of time that are after the occurrence of the event form the second portion of industrial process data.

5. The method as claimed in 1, comprising, prior to the step of retrieving, receiving the triggering signal.

6. The method as claimed in claim 1 comprising creating the triggering signal at predefined instances in time.

7. A computer program product comprising computer-executable components for causing a device to perform the steps recited in claim 1 when the computer-executable components are run on a processor included in the device.
